(19) United States
(12) Patent Application Publication
(10) Pub. No.: US 2025/0358605 A1
(43) Pub. Date: Nov. 20, 2025

(54) Measurement Gaps with Multi-Subscriber Identity Module Operation

(71) Applicant: Apple Inc., Cupertino, CA (US)

(72) Inventors: Qiming Li, Beijing (CN); Yang Tang, San Jose, CA (US); Dawei Zhang, Saratoga, CA (US); Xiang Chen, Palo Alto, CA (US); Jie Cui, San Jose, CA (US); Manasa Raghavan, Sunnyvale, CA (US); Haijing Hu, Los Gatos, CA (US); Yuqin Chen, Beijing (CN)

(21) Appl. No.: 18/873,651

(22) PCT Filed: Jun. 22, 2022
(86) PCT No.: PCT/CN2022/100307

§ 371 Date: Dec. 10, 2024

(51) Int. Cl. H04W 8/18; H04W 8/24; H04W 24/08

(52) U.S. Cl. CPC H04W 8/183; H04W 8/24; H04W 24/08

(57) ABSTRACT

This disclosure relates to techniques for performing multi-subscriber identity module operation in a wireless communication system. A wireless device may be able to simultaneously communicate with two different networks using two different radio frequency chains. The wireless device may indicate this capability to a first wireless network. The first wireless network may select a configuration for the wireless device to use for operations with respect to a second network. The wireless device may communicate with the two networks using the different chains, using the configuration, if applicable.

### FIELD

The present application relates to wireless communications, and more particularly to systems, apparatuses, and methods for performing multi-subscriber identity module operation in a wireless communication system.

### DESCRIPTION OF THE RELATED ART

Wireless communication systems are rapidly growing in usage. In recent years, wireless devices such as smart phones and tablet computers have become increasingly sophisticated. In addition to supporting telephone calls, many mobile devices (i.e., user equipment devices or UEs) now provide access to the internet, email, text messaging, and navigation using the global positioning system (GPS), and are capable of operating sophisticated applications that utilize these functionalities. Additionally, there exist numerous different wireless communication technologies and standards. Some examples of wireless communication standards include GSM, UMTS (associated with, for example, WCDMA or TD-SCDMA air interfaces), LTE, LTE Advanced (LTE-A), NR, HSPA, 3GPP2 CDMA2000 (e.g., 1×RTT, 1×EV-DO, HRPD, eHRPD), IEEE 802.11 (WLAN or Wi-Fi), BLUETOOTH™, etc.

The ever-increasing number of features and functionality introduced in wireless communication devices also creates a continuous need for improvement in both wireless communications and in wireless communication devices. In particular, it is important to ensure the accuracy of transmitted and received signals through user equipment (UE) devices, e.g., through wireless devices such as cellular phones, base stations and relay stations used in wireless cellular communications. In addition, increasing the functionality of a UE device can place a significant strain on the battery life of the UE device. Thus, it is very important to also reduce power requirements in UE device designs while allowing the UE device to maintain good transmit and receive abilities for improved communications. Accordingly, improvements in the field are desired.

### SUMMARY

Embodiments are presented herein of apparatuses, systems, and methods for performing multi-subscriber identity module (MUSIM) operation in a wireless communication system.

In some embodiments, a method at a user equipment device (UE) may comprise establishing communication with a first wireless network using a first subscriber identity module (SIM) of the UE and establishing communication with a second wireless network using a second SIM of the UE, wherein the second SIM of the UE is different than the first SIM of the UE. The method may include determining that the UE the UE is capable of communicating with the first wireless network using a first radio frequency (RF) chain while simultaneously communicating with the second wireless network using a second RF chain. In response to the determination that the UE the UE is capable of communicating with the first wireless network using the first RF chain while simultaneously communicating with the second wireless network using the second RF chain, the method may include transmitting, to the first wireless network, an indication that the UE is capable of using network controlled short gap (NCSG) with respect to the first wireless network for communication with the second wireless network. The method may further include receiving, from the first wireless network, an indication of a first NCSG configuration. In response to the indication, the method may include determining to communicate, with the second wireless network using the second RF chain, during a first portion of a visible interruption repetition period (VIRP) according to the first NCSG configuration and not to communicate with the second wireless network during a second portion of the VIRP according to the first NCSG configuration; and determining to communicate, with the first wireless network using the first RF chain, during the first portion of the VIRP and during the second portion of the VIRP using the first RF chain.

In some embodiments, a method at a user equipment device (UE) may comprise establishing communication with a first wireless network using a first subscriber identity module (SIM) of the UE and establishing communication with a second wireless network using a second SIM of the UE, wherein the second SIM of the UE is different than the first SIM of the UE. The method may include determining that the UE the UE is capable of communicating with the first wireless network using a first radio frequency (RF) chain while simultaneously communicating with the second wireless network using a second RF chain. In response to the determination that the UE the UE is capable of communicating with the first wireless network using the first RF chain while simultaneously communicating with the second wireless network using the second RF chain, the method may include transmitting, to the first wireless network, an indication that the UE has a capability to perform communication with the second wireless network without a measurement gap with respect to the first wireless network; and performing communication with the first wireless network using the first RF chain while simultaneously performing communication with the second wireless network using the second RF chain.

In some embodiments, a method at cellular base station of a first wireless network may include establishing communication with a user equipment device (UE) and receiving, from the UE, an indication that the UE is capable of communicating with the first wireless network using a first radio frequency (RF) chain while simultaneously communicating with the second wireless network using a second RF chain. In response to the indication that the UE the UE is capable of communicating with the first wireless network using the first RF chain while simultaneously communicating with the second wireless network using the second RF chain, the method may include selecting a configuration for the UE to perform operations with respect to the second wireless network; and transmitting, to the UE an indication of the configuration.

Note that the techniques described herein may be implemented in and/or used with a number of different types of devices, including but not limited to base stations, access points, cellular phones, portable media players, tablet computers, wearable devices, unmanned aerial vehicles, unmanned aerial controllers, automobiles and/or motorized vehicles, and various other computing devices.

This Summary is intended to provide a brief overview of some of the subject matter described in this document. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE DRAWINGS

A better understanding of the present subject matter can be obtained when the following detailed description of various embodiments is considered in conjunction with the following drawings.

FIG. 1 illustrates an exemplary (and simplified) wireless communication system, according to some embodiments.

FIG. 2 illustrates an exemplary base station in communication with an exemplary wireless user equipment (UE) device, according to some embodiments.

FIG. 3 illustrates an exemplary block diagram of a UE, according to some embodiments.

FIG. 4 illustrates an exemplary block diagram of a base station, according to some embodiments.

FIG. 5 illustrates an exemplary measurement gap pattern, according to some embodiments.

FIG. 6 is a flowchart diagram illustrating aspects of an exemplary possible method for performing multiple subscriber identity module operation in a wireless communication system, according to some embodiments.

FIG. 7 illustrates an exemplary interruption pattern, according to some embodiments.

While features described herein are susceptible to various modifications and alternative forms, specific embodiments thereof are shown by way of example in the drawings and are herein described in detail. It should be understood, however, that the drawings and detailed description thereto are not intended to be limiting to the particular form disclosed, but on the contrary, the intention is to cover all modifications, equivalents and alternatives falling within the spirit and scope of the subject matter as defined by the appended claims.

### DETAILED DESCRIPTION

### Acronyms

Various acronyms are used throughout the present disclosure. Definitions of the most prominently used acronyms that may appear throughout the present disclosure are provided below:
UE: User Equipment
RF: Radio Frequency
BS: Base Station
GSM: Global System for Mobile Communication
UMTS: Universal Mobile Telecommunication System
LTE: Long Term Evolution
NR: New Radio
TX: Transmission/Transmit
RX: Reception/Receive
RAT: Radio Access Technology
TRP: Transmission-Reception-Point
DCI: Downlink Control Information
CSI: Channel State Information
CQI: Channel Quality Indicator
PMI: Precoding Matrix Indicator
RI: Rank Indicator
MUSIM: Multiple Subscriber Identity Module
SIM: Subscriber Identity Module
NCSG: Network Controlled Small Gap

### Terms

The following is a glossary of terms that may appear in the present disclosure:

Memory Medium—Any of various types of non-transitory memory devices or storage devices. The term “memory medium” is intended to include an installation medium, e.g., a CD-ROM, floppy disks, or tape device; a computer system memory or random access memory such as DRAM, DDR RAM, SRAM, EDO RAM, Rambus RAM, etc.; a non-volatile memory such as a Flash, magnetic media, e.g., a hard drive, or optical storage; registers, or other similar types of memory elements, etc. The memory medium may include other types of non-transitory memory as well or combinations thereof. In addition, the memory medium may be located in a first computer system in which the programs are executed, or may be located in a second different computer system which connects to the first computer system over a network, such as the Internet. In the latter instance, the second computer system may provide program instructions to the first computer system for execution. The term “memory medium” may include two or more memory mediums which may reside in different locations, e.g., in different computer systems that are connected over a network. The memory medium may store program instructions (e.g., embodied as computer programs) that may be executed by one or more processors.

Carrier Medium—a memory medium as described above, as well as a physical transmission medium, such as a bus, network, and/or other physical transmission medium that conveys signals such as electrical, electromagnetic, or digital signals.

Computer System (or Computer)—any of various types of computing or processing systems, including a personal computer system (PC), mainframe computer system, workstation, network appliance, Internet appliance, personal digital assistant (PDA), television system, grid computing system, or other device or combinations of devices. In general, the term “computer system” may be broadly defined to encompass any device (or combination of devices) having at least one processor that executes instructions from a memory medium. User Equipment (UE) (or “UE Device”)—any of various types of computer systems or devices that are mobile or portable and that perform wireless communications. Examples of UE devices include mobile telephones or smart phones (e.g., iPhone™, Android™-based phones), tablet computers (e.g., iPad™, Samsung Galaxy™), portable gaming devices (e.g., Nintendo DS™, PlayStation Portable™, Gameboy Advance™, iPhone™), wearable devices (e.g., smart watch, smart glasses), laptops, PDAs, portable Internet devices, music players, data storage devices, other handheld devices, automobiles and/or motor vehicles, unmanned aerial vehicles (UAVs) (e.g., drones), UAV controllers (UACs), etc. In general, the term “UE” or “UE device” can be broadly defined to encompass any electronic, computing, and/or telecommunications device (or combination of devices) which is easily transported by a user and capable of wireless communication.

Wireless Device—any of various types of computer systems or devices that perform wireless communications. A wireless device can be portable (or mobile) or may be stationary or fixed at a certain location. A UE is an example of a wireless device.

Communication Device—any of various types of computer systems or devices that perform communications, where the communications can be wired or wireless. A communication device can be portable (or mobile) or may be stationary or fixed at a certain location. A wireless device is an example of a communication device. A UE is another example of a communication device.

Base Station (BS)—The term “Base Station” has the full breadth of its ordinary meaning, and at least includes a wireless communication station installed at a fixed location and used to communicate as part of a wireless telephone system or radio system.

Processing Element (or Processor)—refers to various elements or combinations of elements that are capable of performing a function in a device, e.g., in a user equipment device or in a cellular network device. Processing elements may include, for example: processors and associated memory, portions or circuits of individual processor cores, entire processor cores, processor arrays, circuits such as an ASIC (Application Specific Integrated Circuit), programmable hardware elements such as a field programmable gate array (FPGA), as well any of various combinations of the above.

Wi-Fi—The term “Wi-Fi” has the full breadth of its ordinary meaning, and at least includes a wireless communication network or RAT that is serviced by wireless LAN (WLAN) access points and which provides connectivity through these access points to the Internet. Most modern Wi-Fi networks (or WLAN networks) are based on IEEE 802.11 standards and are marketed under the name “Wi-Fi”. A Wi-Fi (WLAN) network is different from a cellular network.

Automatically—refers to an action or operation performed by a computer system (e.g., software executed by the computer system) or device (e.g., circuitry, programmable hardware elements, ASICs, etc.), without user input directly specifying or performing the action or operation. Thus, the term “automatically” is in contrast to an operation being manually performed or specified by the user, where the user provides input to directly perform the operation. An automatic procedure may be initiated by input provided by the user, but the subsequent actions that are performed “automatically” are not specified by the user, i.e., are not performed “manually”, where the user specifies each action to perform. For example, a user filling out an electronic form by selecting each field and providing input specifying information (e.g., by typing information, selecting check boxes, radio selections, etc.) is filling out the form manually, even though the computer system must update the form in response to the user actions. The form may be automatically filled out by the computer system where the computer system (e.g., software executing on the computer system) analyzes the fields of the form and fills in the form without any user input specifying the answers to the fields. As indicated above, the user may invoke the automatic filling of the form, but is not involved in the actual filling of the form (e.g., the user is not manually specifying answers to fields but rather they are being automatically completed). The present specification provides various examples of operations being automatically performed in response to actions the user has taken.

Configured to—Various components may be described as “configured to” perform a task or tasks. In such contexts, “configured to” is a broad recitation generally meaning “having structure that” performs the task or tasks during operation. As such, the component can be configured to perform the task even when the component is not currently performing that task (e.g., a set of electrical conductors may be configured to electrically connect a module to another module, even when the two modules are not connected). In some contexts, “configured to” may be a broad recitation of structure generally meaning “having circuitry that” performs the task or tasks during operation. As such, the component can be configured to perform the task even when the component is not currently on. In general, the circuitry that forms the structure corresponding to “configured to” may include hardware circuits.

Various components may be described as performing a task or tasks, for convenience in the description. Such descriptions should be interpreted as including the phrase “configured to.” Reciting a component that is configured to perform one or more tasks is expressly intended not to invoke 35 U.S.C. § 112, paragraph six, interpretation for that component.

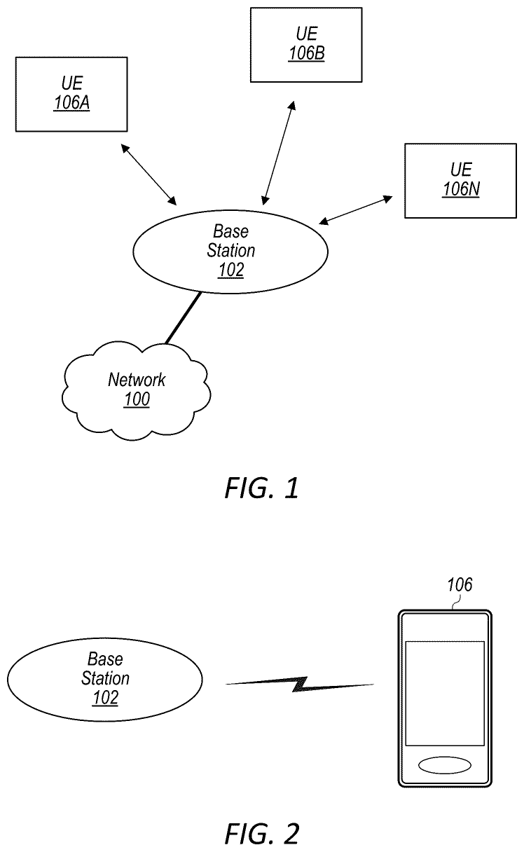

### FIGS. 1 and 2—Exemplary Communication System

FIG. 1 illustrates an exemplary (and simplified) wireless communication system in which aspects of this disclosure may be implemented, according to some embodiments. It is noted that the system of FIG. 1 is merely one example of a possible system, and embodiments may be implemented in any of various systems, as desired.

As shown, the exemplary wireless communication system includes a base station 102 which communicates over a transmission medium with one or more (e.g., an arbitrary number of) user devices 106A, 106B, etc. through 106N. Each of the user devices may be referred to herein as a “user equipment” (UE) or UE device. Thus, the user devices 106 are referred to as UEs or UE devices.

The base station 102 may be a base transceiver station (BTS) or cell site, and may include hardware and/or software that enables wireless communication with the UEs 106A through 106N. If the base station 102 is implemented in the context of LTE, it may alternately be referred to as an ‘eNodeB’ or ‘eNB’. If the base station 102 is implemented in the context of 5G NR, it may alternately be referred to as a ‘gNodeB’ or ‘gNB’. The base station 102 may also be equipped to communicate with a network 100 (e.g., a core network of a cellular service provider, a telecommunication network such as a public switched telephone network (PSTN), and/or the Internet, among various possibilities). Thus, the base station 102 may facilitate communication among the user devices and/or between the user devices and the network 100. The communication area (or coverage area) of the base station may be referred to as a “cell.” As also used herein, from the perspective of UEs, a base station may sometimes be considered as representing the network insofar as uplink and downlink communications of the UE are concerned. Thus, a UE communicating with one or more base stations in the network may also be interpreted as the UE communicating with the network.

The base station 102 and the user devices may be configured to communicate over the transmission medium using any of various radio access technologies (RATs), also referred to as wireless communication technologies, or telecommunication standards, such as GSM, UMTS (WCDMA), LTE, LTE-Advanced (LTE-A), LAA/LTE-U, 5G NR, 3GPP2 CDMA2000 (e.g., 1×RTT, 1×EV-DO, HRPD, cHRPD), Wi-Fi, etc.

Base station 102 and other similar base stations operating according to the same or a different cellular communication standard may thus be provided as one or more networks of cells, which may provide continuous or nearly continuous overlapping service to UE 106 and similar devices over a geographic area via one or more cellular communication standards.

Note that a UE 106 may be capable of communicating using multiple wireless communication standards. For example, a UE 106 might be configured to communicate using either or both of a 3GPP cellular communication standard or a 3GPP2 cellular communication standard. In some embodiments, the UE 106 may be configured to perform techniques for performing multi-subscriber identity module (MUSIM) operation in a wireless communication system, such as according to the various methods described herein. The UE 106 might also or alternatively be configured to communicate using WLAN, BLUETOOTH™, one or more global navigational satellite systems (GNSS, e.g., GPS or GLONASS), one and/or more mobile television broadcasting standards (e.g., ATSC-M/H), etc. Other combinations of wireless communication standards (including more than two wireless communication standards) are also possible.

FIG. 2 illustrates an exemplary user equipment 106 (e.g., one of the devices 106A through 106N) in communication with the base station 102, according to some embodiments. The UE 106 may be a device with wireless network connectivity such as a mobile phone, a hand-held device, a wearable device, a computer or a tablet, an unmanned aerial vehicle (UAV), an unmanned aerial controller (UAC), an automobile, or virtually any type of wireless device. The UE 106 may include a processor (processing element) that is configured to execute program instructions stored in memory. The UE 106 may perform any of the method embodiments described herein by executing such stored instructions. Alternatively, or in addition, the UE 106 may include a programmable hardware element such as an FPGA (field-programmable gate array), an integrated circuit, and/or any of various other possible hardware components that are configured to perform (e.g., individually or in combination) any of the method embodiments described herein, or any portion of any of the method embodiments described herein. The UE 106 may be configured to communicate using any of multiple wireless communication protocols. For example, the UE 106 may be configured to communicate using two or more of CDMA2000, LTE, LTE-A, 5G NR, WLAN, or GNSS. Other combinations of wireless communication standards are also possible.

The UE 106 may include one or more antennas for communicating using one or more wireless communication protocols according to one or more RAT standards. In some embodiments, the UE 106 may share one or more parts of a receive chain and/or transmit chain between multiple wireless communication standards. The shared radio may include a single antenna, or may include multiple antennas (e.g., for multiple-input, multiple-output or “MIMO”) for performing wireless communications. In general, a radio may include any combination of a baseband processor, analog RF signal processing circuitry (e.g., including filters, mixers, oscillators, amplifiers, etc.), or digital processing circuitry (e.g., for digital modulation as well as other digital processing). Similarly, the radio may implement one or more receive and transmit chains using the aforementioned hardware. For example, the UE 106 may share one or more parts of a receive and/or transmit chain between multiple wireless communication technologies, such as those discussed above.

In some embodiments, the UE 106 may include any number of antennas and may be configured to use the antennas to transmit and/or receive directional wireless signals (e.g., beams). Similarly, the BS 102 may also include any number of antennas and may be configured to use the antennas to transmit and/or receive directional wireless signals (e.g., beams). To receive and/or transmit such directional signals, the antennas of the UE 106 and/or BS 102 may be configured to apply different “weight” to different antennas. The process of applying these different weights may be referred to as “precoding”.

In some embodiments, the UE 106 may include separate transmit and/or receive chains (e.g., including separate antennas and other radio components) for each wireless communication protocol with which it is configured to communicate. As a further possibility, the UE 106 may include one or more radios that are shared between multiple wireless communication protocols, and one or more radios that are used exclusively by a single wireless communication protocol. For example, the UE 106 may include a shared radio for communicating using either of LTE or CDMA2000 1×RTT (or LTE or NR, or LTE or GSM), and separate radios for communicating using each of Wi-Fi and BLUETOOTH™. Other configurations are also possible.

In some embodiments, the UE 106 may include multiple subscriber identity modules (SIMs, sometimes referred to as SIM cards). In other words, the UE 106 may be a multi-SIM (MUSIM) device, such as a dual-SIM device. Any of the various SIMs may be physical SIMs (e.g., SIM cards) or embedded (e.g., virtual) SIMs. Any combination of physical and/or virtual SIMs may be included. Each SIM may provide various services (e.g., packet switched and/or circuit switched services) to the user. In some embodiments, UE 106 may share common RF (e.g., Tx and/or Rx) chains for multiple SIMs (e.g., UE 106 may have a dual SIM dual standby architecture). Other architectures are possible. For example, UE 106 may be a dual SIM dual active architecture, may include separate Tx and/or Rx chains for the various SIMs, may include more than two SIMs, etc.

The different identities (e.g., different SIMs) may have different identifiers, e.g., different UE identities (UE IDs). For example, an international mobile subscriber identity (IMSI) may be an identity associated with a SIM (e.g., in a MUSIM device each SIM may have its own IMSI). The IMSI may be unique. Similarly, each SIM may have its own unique international mobile equipment identity (IMEI). Thus, the IMSI and/or IMEI may be examples of possible UE IDs, however other identifiers may be used as UE ID.

The different identities may have the same or different relationships to various public land mobile networks (PLMNs). For example, a first identity may have a first home PLMN, while a second identity may have a different home PLMN. In such cases, one identity may be camped on a home network (e.g., on a cell provided by BS 102) while another identity may be roaming (e.g., while also camped on the same cell provided by BS 102, or a different cell provided by the same or different BS 102). In other circumstances, multiple identities may be concurrently home (e.g., on the same or different cells of the same or different networks) or may be concurrently roaming (e.g., on the same or different cells of the same or different networks). As will be appreciated, numerous combinations are possible. For example, two SIM subscriptions on a MUSIM device may belong to the same equivalent/carrier (e.g., AT&T/AT&T or CMCC/CMCC). As another exemplary possibility, SIM-A may be roaming into SIM-B's network (SIM-A CMCC user roaming into AT&T and SIM-B is also AT&T).

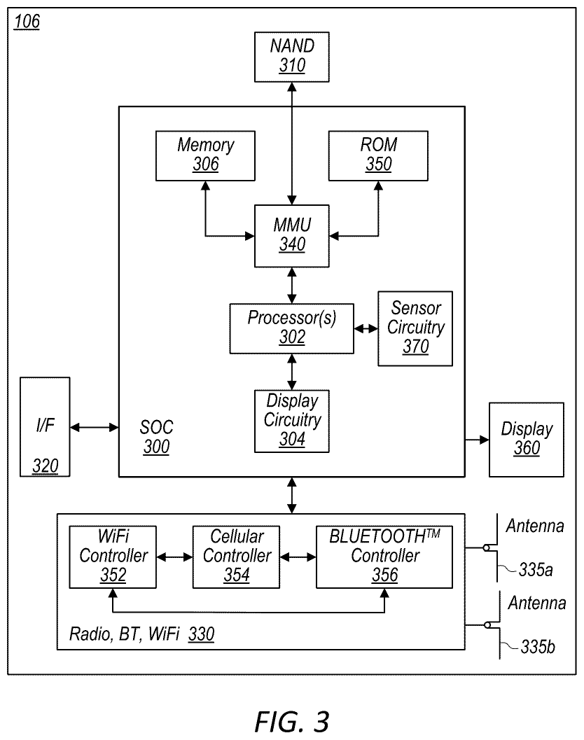

### FIG. 3—Block Diagram of an Exemplary UE Device

FIG. 3 illustrates a block diagram of an exemplary UE 106, according to some embodiments. As shown, the UE 106 may include a system on chip (SOC) 300, which may include portions for various purposes. For example, as shown, the SOC 300 may include processor(s) 302 which may execute program instructions for the UE 106 and display circuitry 304 which may perform graphics processing and provide display signals to the display 360. The SOC 300 may also include sensor circuitry 370, which may include components for sensing or measuring any of a variety of possible characteristics or parameters of the UE 106. For example, the sensor circuitry 370 may include motion sensing circuitry configured to detect motion of the UE 106, for example using a gyroscope, accelerometer, and/or any of various other motion sensing components. As another possibility, the sensor circuitry 370 may include one or more temperature sensing components, for example for measuring the temperature of each of one or more antenna panels and/or other components of the UE 106. Any of various other possible types of sensor circuitry may also or alternatively be included in UE 106, as desired. The processor(s) 302 may also be coupled to memory management unit (MMU) 340, which may be configured to receive addresses from the processor(s) 302 and translate those addresses to locations in memory (e.g., memory 306, read only memory (ROM) 350, NAND flash memory 310) and/or to other circuits or devices, such as the display circuitry 304, radio 330, connector I/F 320, and/or display 360. The MMU 340 may be configured to perform memory protection and page table translation or set up. In some embodiments, the MMU 340 may be included as a portion of the processor(s) 302.

As shown, the SOC 300 may be coupled to various other circuits of the UE 106. For example, the UE 106 may include various types of memory (e.g., including NAND flash 310), a connector interface 320 (e.g., for coupling to a computer system, dock, charging station, etc.), the display 360, and wireless communication circuitry 330 (e.g., for LTE, LTE-A, NR, CDMA2000, BLUETOOTH™, Wi-Fi, GPS, etc.). The UE device 106 may include or couple to at least one antenna (e.g., 335a), and possibly multiple antennas (e.g., illustrated by antennas 335a and 335b), for performing wireless communication with base stations and/or other devices. Antennas 335a and 335b are shown by way of example, and UE device 106 may include fewer or more antennas. Overall, the one or more antennas are collectively referred to as antenna 335. For example, the UE device 106 may use antenna 335 to perform the wireless communication with the aid of radio circuitry 330. The communication circuitry may include multiple radio frequency (RF) chains. For example, multiple receive chains and/or multiple transmit chains may be used for receiving and/or transmitting multiple spatial streams, such as in a multiple-input multiple output (MIMO) configuration, and/or on multiple frequencies/frequency ranges. For example, different RF chains may be used for communication with different cells, TRPs, networks, etc. An RF chain may include one or more antennas and/or other hardware such as phase shifter, oscillator, filter, radio, baseband processer, etc., among various possibilities. In some embodiments, multiple RF chains may share a radio and/or other hardware. As noted above, the UE may be configured to communicate wirelessly using multiple wireless communication standards in some embodiments.

The UE 106 may include hardware and software components for implementing methods for the UE 106 to perform techniques for performing MUSIM operation in a wireless communication system, such as described further subsequently herein. The processor(s) 302 of the UE device 106 may be configured to implement part or all of the methods described herein, e.g., by executing program instructions stored on a memory medium (e.g., a non-transitory computer-readable memory medium). In other embodiments, processor(s) 302 may be configured as a programmable hardware element, such as an FPGA (Field Programmable Gate Array), or as an ASIC (Application Specific Integrated Circuit). Furthermore, processor(s) 302 may be coupled to and/or may interoperate with other components as shown in FIG. 3, to perform techniques for performing MUSIM operation in a wireless communication system according to various embodiments disclosed herein. Processor(s) 302 may also implement various other applications and/or end-user applications running on UE 106.

In some embodiments, radio 330 may include separate controllers dedicated to controlling communications for various respective RAT standards. For example, as shown in FIG. 3, radio 330 may include a Wi-Fi controller 352, a cellular controller (e.g., LTE and/or LTE-A controller) 354, and BLUETOOTH™ controller 356, and in at least some embodiments, one or more or all of these controllers may be implemented as respective integrated circuits (ICs or chips, for short) in communication with each other and with SOC 300 (and more specifically with processor(s) 302). For example, Wi-Fi controller 352 may communicate with cellular controller 354 over a cell-ISM link or WCI interface, and/or BLUETOOTH™ controller 356 may communicate with cellular controller 354 over a cell-ISM link, etc. While three separate controllers are illustrated within radio 330, other embodiments have fewer or more similar controllers for various different RATs that may be implemented in UE device 106.

Further, embodiments in which controllers may implement functionality associated with multiple radio access technologies are also envisioned. For example, according to some embodiments, the cellular controller 354 may, in addition to hardware and/or software components for performing cellular communication, include hardware and/or software components for performing one or more activities associated with Wi-Fi, such as Wi-Fi preamble detection, and/or generation and transmission of Wi-Fi physical layer preamble signals.

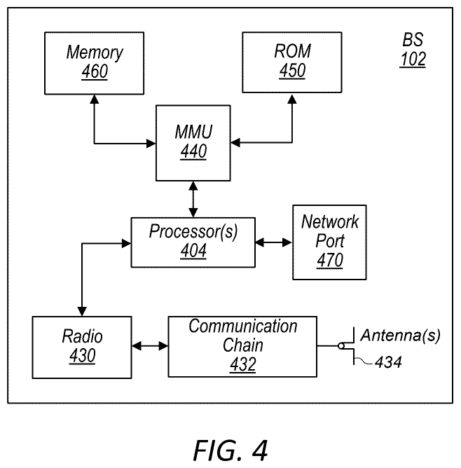

### FIG. 4—Block Diagram of an Exemplary Base Station

FIG. 4 illustrates a block diagram of an exemplary base station 102, according to some embodiments. It is noted that the base station of FIG. 4 is merely one example of a possible base station. As shown, the base station 102 may include processor(s) 404 which may execute program instructions for the base station 102. The processor(s) 404 may also be coupled to memory management unit (MMU) 440, which may be configured to receive addresses from the processor(s) 404 and translate those addresses to locations in memory (e.g., memory 460 and read only memory (ROM) 450) or to other circuits or devices.

The base station 102 may include at least one network port 470. The network port 470 may be configured to couple to a telephone network and provide a plurality of devices, such as UE devices 106, access to the telephone network as described above in FIGS. 1 and 2. The network port 470 (or an additional network port) may also or alternatively be configured to couple to a cellular network, e.g., a core network of a cellular service provider. The core network may provide mobility related services and/or other services to a plurality of devices, such as UE devices 106. In some cases, the network port 470 may couple to a telephone network via the core network, and/or the core network may provide a telephone network (e.g., among other UE devices serviced by the cellular service provider).

In some embodiments, base station 102 may be a next generation base station, e.g., a 5G New Radio (5G NR) base station, or “gNB”. In such embodiments, base station 102 may be connected to a legacy evolved packet core (EPC) network and/or to a NR core (NRC) network. In addition, base station 102 may be considered a 5G NR cell and may include one or more transmission and reception points (TRPs). In addition, a UE capable of operating according to 5G NR may be connected to one or more TRPs within one or more gNBs.

The base station 102 may include at least one antenna 434, and possibly multiple antennas. The antenna(s) 434 may be configured to operate as a wireless transceiver and may be further configured to communicate with UE devices 106 via radio 430. The antenna(s) 434 communicates with the radio 430 via communication chain 432. Communication chain 432 may be a receive chain, a transmit chain or both. The radio 430 may be designed to communicate via various wireless telecommunication standards, including, but not limited to, 5G NR, 5G NR SAT, LTE, LTE-A, GSM, UMTS, CDMA2000, Wi-Fi, etc.

The base station 102 may be configured to communicate wirelessly using multiple wireless communication standards. In some instances, the base station 102 may include multiple radios, which may enable the base station 102 to communicate according to multiple wireless communication technologies. For example, as one possibility, the base station 102 may include an LTE radio for performing communication according to LTE as well as a 5G NR radio for performing communication according to 5G NR. In such a case, the base station 102 may be capable of operating as both an LTE base station and a 5G NR base station. As another possibility, the base station 102 may include a multi-mode radio which is capable of performing communications according to any of multiple wireless communication technologies (e.g., 5G NR and Wi-Fi, 5G NR SAT and Wi-Fi, LTE and Wi-Fi, LTE and UMTS, LTE and CDMA2000, UMTS and GSM, etc.).

As described further subsequently herein, the BS 102 may include hardware and software components for implementing or supporting implementation of features described herein. The processor 404 of the base station 102 may be configured to implement and/or support implementation of part or all of the methods described herein, e.g., by executing program instructions stored on a memory medium (e.g., a non-transitory computer-readable memory medium). Alternatively, the processor 404 may be configured as a programmable hardware element, such as an FPGA (Field Programmable Gate Array), or as an ASIC (Application Specific Integrated Circuit), or a combination thereof. In the case of certain RATs, for example Wi-Fi, base station 102 may be designed as an access point (AP), in which case network port 470 may be implemented to provide access to a wide area network and/or local area network(s), e.g., it may include at least one Ethernet port, and radio 430 may be designed to communicate according to the Wi-Fi standard.

In addition, as described herein, processor(s) 404 may include one or more processing elements. Thus, processor(s) 404 may include one or more integrated circuits (ICs) that are configured to perform the functions of processor(s) 404. In addition, each integrated circuit may include circuitry (e.g., first circuitry, second circuitry, etc.) configured to perform the functions of processor(s) 404.

Further, as described herein, radio 430 may include one or more processing elements. Thus, radio 430 may include one or more integrated circuits (ICs) that are configured to perform the functions of radio 430. In addition, each integrated circuit may include circuitry (e.g., first circuitry, second circuitry, etc.) configured to perform the functions of radio 430.

### Reference Signals

A wireless device, such as a user equipment, may be configured to perform a variety of tasks that include the use of reference signals (RS) provided by one or more cellular base stations. For example, initial access and beam measurement by a wireless device may be performed based at least in part on synchronization signal blocks (SSBs) provided by one or more cells provided by one or more cellular base stations within communicative range of the wireless device. Another type of reference signal commonly provided in a cellular communication system may include channel state information (CSI) RS. Various types of CSI-RS may be provided for tracking (e.g., for time and frequency offset tracking), beam management (e.g., with repetition configured, to assist with determining one or more beams to use for uplink and/or downlink communication), and/or channel measurement (e.g., CSI-RS configured in a resource set for measuring the quality of the downlink channel and reporting information related to this quality measurement to the base station), among various possibilities. For example, in the case of CSI-RS for CSI acquisition, the UE may periodically perform channel measurements and send channel state information (CSI) to a BS. The base station can then receive and use this channel state information to determine an adjustment of various parameters during communication with the wireless device. In particular, the BS may use the received channel state information to adjust the coding of its downlink transmissions to improve downlink channel quality.

In many cellular communication systems, the base station may transmit some or all such reference signals (or pilot signals), such as SSB and/or CSI-RS, on a periodic basis. In some instances, aperiodic reference signals (e.g., for aperiodic CSI reporting) may also or alternatively be provided.

As a detailed example, in the 3GPP NR cellular communication standard, the channel state information fed back from the UE based on CSI-RS for CSI acquisition may include one or more of a channel quality indicator (CQI), a precoding matrix indicator (PMI), a rank indicator (RI), a CSI-RS Resource Indicator (CRI), a SSBRI (SS/PBCH Resource Block Indicator, and a Layer Indicator (LI), at least according to some embodiments.

The channel quality information may be provided to the base station for link adaptation, e.g., for providing guidance as to which modulation & coding scheme (MCS) the base station should use when it transmits data. For example, when the downlink channel communication quality between the base station and the UE is determined to be high, the UE may feed back a high CQI value, which may cause the base station to transmit data using a relatively high modulation order and/or a low channel coding rate. As another example, when the downlink channel communication quality between the base station and the UE is determined to be low, the UE may feed back a low CQI value, which may cause the base station to transmit data using a relatively low modulation order and/or a high channel coding rate.

PMI feedback may include preferred precoding matrix information, and may be provided to a base station in order to indicate which MIMO precoding scheme the base station should use. In other words, the UE may measure the quality of a downlink MIMO channel between the base station and the UE, based on a pilot signal received on the channel, and may recommend, through PMI feedback, which MIMO precoding is desired to be applied by the base station. In some cellular systems, the PMI configuration is expressed in matrix form, which provides for linear MIMO precoding. The base station and the UE may share a codebook composed of multiple precoding matrixes, where each MIMO precoding matrix in the codebook may have a unique index. Accordingly, as part of the channel state information fed back by the UE, the PMI may include an index (or possibly multiple indices) corresponding to the most preferred MIMO precoding matrix (or matrixes) in the codebook. This may enable the UE to minimize the amount of feedback information. Thus, the PMI may indicate which precoding matrix from a codebook should be used for transmissions to the UE, at least according to some embodiments.

The rank indicator information (RI feedback) may indicate a number of transmission layers that the UE determines can be supported by the channel, e.g., when the base station and the UE have multiple antennas, which may enable multi-layer transmission through spatial multiplexing. The RI and the PMI may collectively allow the base station to know which precoding needs to be applied to which layer, e.g., depending on the number of transmission layers.

In some cellular systems, a PMI codebook is defined depending on the number of transmission layers. In other words, for R-layer transmission, N number of Nₜ×R matrixes may be defined (e.g., where R represents the number of layers, Ni represents the number of transmitter antenna ports, and N represents the size of the codebook). In such a scenario, the number of transmission layers (R) may conform to a rank value of the precoding matrix (Nₜ×R matrix), and hence in this context R may be referred to as the “rank indicator (RI)”.

Thus, the channel state information may include an allocated rank (e.g., a rank indicator or RI). For example, a MIMO-capable UE communicating with a BS may include four receiver chains, e.g., may include four antennas. The BS may also include four or more antennas to enable MIMO communication (e.g., 4×4 MIMO). Thus, the UE may be capable of receiving up to four (or more) signals (e.g., layers) from the BS concurrently. Layer to antenna mapping may be applied, e.g., each layer may be mapped to any number of antenna ports (e.g., antennas). Each antenna port may send and/or receive information associated with one or more layers. The rank may include multiple bits and may indicate the number of signals that the BS may send to the UE in an upcoming time period (e.g., during an upcoming transmission time interval or TTI). For example, an indication of rank 4 may indicate that the BS will send 4 signals to the UE. As one possibility, the RI may be two bits in length (e.g., since two bits are sufficient to distinguish 4 different rank values). Note that other numbers and/or configurations of antennas (e.g., at either or both of the UE or the BS) and/or other numbers of data layers are also possible, according to various embodiments.

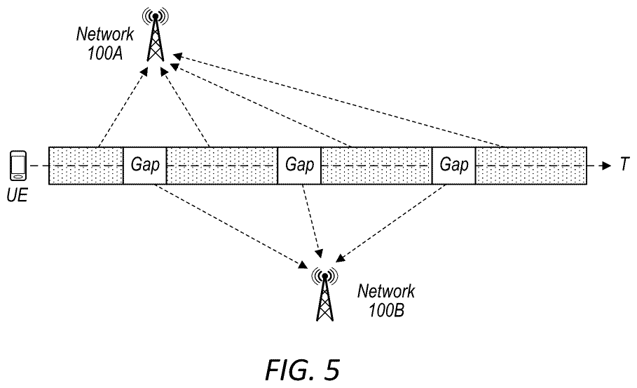

### FIG. 5—Gaps for MUSIM Operation

According to some cellular communication technologies, it may be possible for a wireless device to communicate with multiple wireless networks (e.g., cellular networks), including potentially simultaneously. For example, a UE may use a first subscriber identity module (SIM) for communication with a first network and a second SIM for a second network. Such operation may be referred to as multi-SIM (MUSIM) operation.

In release 17 (R17), 3GPP introduced a work item for MUSIM operation. Justification for improvements of MUSIM is discussed in RP-212610. Multi-SIM devices may have been more and more popular in different countries. For example, a user may have both a personal and a business subscription in one device and/or may have two personal subscriptions in one device for different services (e.g., one individual subscription and one “family circle” plan). However, support for multi-SIM within a device may be currently handled in an implementation-specific manner without any support from 3GPP specifications, resulting in a variety of implementations and UE behaviors.

Standardizing support for such UEs may support performance, e.g., in that network functionality can be based on predictable UE behavior, e.g., by improving reception of pages and/or other communications at the UE. For example, UEs that are registered to more than one network may attempt to receive pages from more than one network. In the absence of a coordination mechanism, depending on UE capabilities (e.g., receive and transmit capabilities) a UE may be occupied listening to pages from one network while pages from other networks also may be sent. Similarly, UEs may be actively communicating with one network while another network pages the UE. Further, if a user switches between communications towards different networks, situations may occur when a UE/user can no longer receive data from a network it was recently communicating in. Such situations can have a negative impact on performance, e.g., if pages are sent and not properly received, or if users are scheduled while not being able to receive communication.

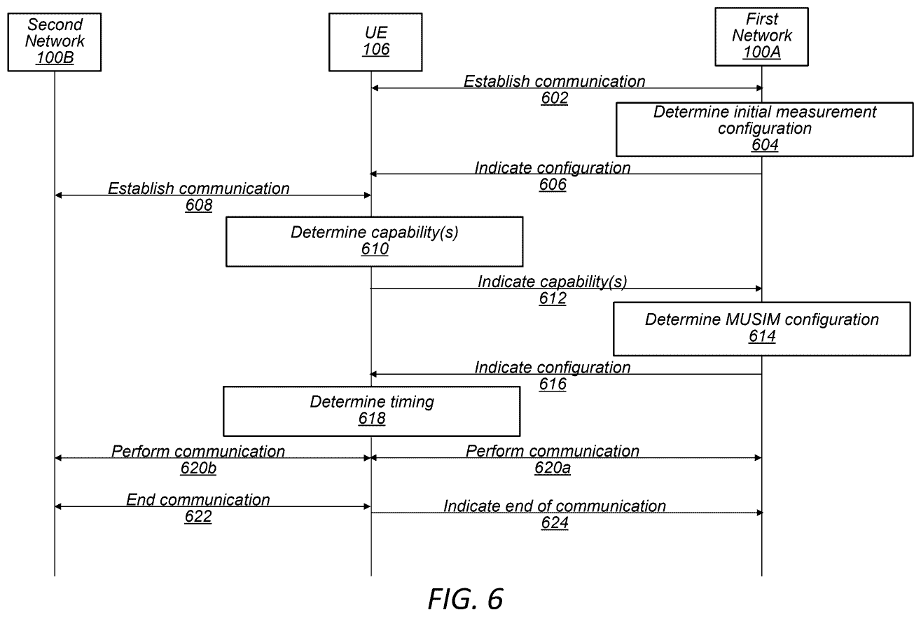

One approach to such standardization may be to configure gaps with respect to one network for a UE to use for operations with respect to another network. For example, as shown in FIG. 6, network 100A may configure a series of gaps. In R17, NR introduced several new measurement gap patterns for a UE to perform such MUSIM operations toward network 100B, including system information (SI) reading, radio resource management (RRM) measurement, paging reception, etc. A UE may use these gaps to communicate with (e.g., perform measurements, receive pages, etc.) with a second network 100B. In some embodiments, the UE may tune away from network 100A during the gaps and tune to network 100B. Thus, the UE may be unavailable from the perspective of network 100A during the gaps and unavailable from the perspective of network 100B in between the gaps. When the UE is unavailable from the perspective of the network, it may not be able to receive downlink traffic from that network (e.g., because it is tuned to a frequency (frequencies) and/or spatial beam(s) corresponding to a different network). Using measurement gap for MUSIM operation toward network 100B may result in (e.g., long) interruptions on connection with network 100A. For example, when network 100A and network 100B belong to different operators, network 100A may have no strong interest to configure MUSIM gap for network 100B since such gaps may degrade throughput in network 100A.

### FIG. 6—Scheduling MUSIM Operation

In order to reduce or avoid unavailability of a UE associated with tuning away from a network, it may be beneficial to specify techniques for supporting effective scheduling of MUSIM scenarios, e.g., in the case that a UE has capability to communicate with two networks simultaneously. To illustrate one such set of possible techniques, FIG. 6 is a communication flow diagram illustrating a method for performing MUSIM operation in a wireless communication system, at least according to some embodiments. The methods of FIG. 6 may include enhancements to avoid performance degradations of the above mentioned and other situations that may occur when UE's can communicate with more than one system via MUSIM support.

Aspects of the method of FIG. 6 may be implemented by a wireless device, e.g., in conjunction with one or more networks e.g., via one or more cellular base stations, such as a UE 106 and a BS 102 illustrated in and described with respect to various of the Figures herein, or more generally in conjunction with any of the computer circuitry, systems, devices, elements, or components shown in the above Figures, among others, as desired. For example, a processor (and/or other hardware) of such a device may be configured to cause the device to perform any combination of the illustrated method elements and/or other method elements.

Note that while at least some elements of the method of FIG. 6 are described in a manner relating to the use of communication techniques and/or features associated with 3GPP and/or NR specification documents, such description is not intended to be limiting to the disclosure, and aspects of the method of FIG. 5 may be used in any suitable wireless communication system, as desired. In various embodiments, some of the elements of the methods shown may be performed concurrently, in a different order than shown, may be substituted for by other method elements, or may be omitted. Additional method elements may also be performed as desired. As shown, the method of FIG. 6 may operate as follows.

The UE may establish communication with a first wireless network (e.g., network 100A) (602), according to some embodiments. The communication may be via a wireless link with a cellular base station. According to some embodiments, the wireless link may include a cellular link according to 5G NR. For example, the wireless device may establish a session with an access and mobility management function (AMF) entity of the cellular network by way of one or more gNBs that provide radio access to the cellular network. As another possibility, the wireless link may include a cellular link according to LTE. For example, the wireless device may establish a session with a mobility management entity of the cellular network by way of an cNB that provides radio access to the cellular network. Other types of cellular links are also possible, and the cellular network may also or alternatively operate according to another cellular communication technology (e.g., UMTS, CDMA2000, GSM, etc.), according to various embodiments.

Establishing communication may include establishing a radio resource control (RRC) connection with a serving cellular base station, at least according to some embodiments. Establishing the first RRC connection may include configuring various parameters for communication between the UE and the cellular base station, establishing context information for the UE, and/or any of various other possible features, e.g., relating to establishing an air interface for the wireless device to perform cellular communication with a cellular network associated with the cellular base station. After establishing the RRC connection, the UE may operate in a RRC connected state. In some instances, the RRC connection may also be released (e.g., after a certain period of inactivity with respect to data communication), in which case the UE may operate in a RRC idle state or a RRC inactive state. In some instances, the UE may perform handover (e.g., while in RRC connected mode) or cell re-selection (e.g., while in RRC idle or RRC inactive mode) to a new serving cell, e.g., due to wireless device mobility, changing wireless medium conditions, and/or for any of various other possible reasons.

At least according to some embodiments, the UE may establish multiple wireless links, e.g., with multiple transmission reception points (TRPs) of the first network, according to a multi-TRP configuration. Similarly, the UE may establish links with multiple cells of the first network.

At least in some instances, establishing the wireless link(s) may include the wireless device providing capability information for the wireless device. Such capability information may include information relating to any of a variety of types of wireless device capabilities.

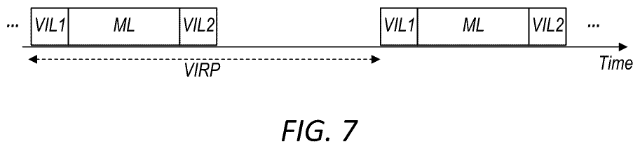

In some embodiments, the UE and the network 100A may exchange capability information. The capability information may include information related to the UE's capability and/or time requirements related to switching one or more RF chain between one network and another (e.g., between network 100A and network 100B). Similarly, the capability information may include information related to the UE's capability and/or time requirements related to switching one or more RF chain between one frequency band (or set of carriers) of network 100A and another frequency band (e.g., set of carriers) of network 100A, e.g., for measurements. For example, the UE may provide timing requirement information for the time periods illustrated in FIG. 7 and as discussed in TS 38.133 for network controlled small gap (NCSG) operation. As one possibility, the capability information provided by the UE may include two parts: 1) support for the functionality of using NCSG pattern for MUSIM; 2) which NCSG pattern(s) are supported. For example, the UE may indicate a measurement length (ML) and one or more visible interruption length (VIL), e.g., VIL1 before the ML and VIL2 after the ML. VIL1 and VIL2 may be the same or they may be different. The VIL may indicate the amount of time that the UE is not available to transmit or receive data, e.g., due to switching one or more RF chain from one frequency or network to another. From the network perspective, during the VIL1 and VIL2, the UE may not be expected to transmit and receive any data (e.g., with either network). During ML, whether the UE is expected to transmit and receive data on the corresponding serving carrier(s) may depend on a scheduling restriction, e.g., as configured in carrier information. In the case that the capability information relates to switching between networks, ML (e.g., which may be relabeled) may refer to the amount of time required for the UE to operate on the other network (e.g., 100B). However, the UE may be able to communicate with both networks during the ML, e.g., using different RF chains simultaneously, e.g., one or more RF chain for each network. It will be appreciated that different ML, VIL1, and/or VIL2 values may be configured for different uses (e.g., measurements of other frequency bands vs. switching to a different network). Similarly, time periods similar to those used for the NeedForGap design from R16 may be configured, according to some embodiments.

The capability information may be exchanged using any of various types of signaling/messages. For example, the UE and network may use RRC signaling, such as one or more information elements (IE).

As one possibility, the UE may use an IE specific for MUSIM operation (e.g., NCSGforMUSIM) to provide capability information such as MIL, VIL1, and/or VIL2 for switching to/from the second network. The IE (e.g., NCSGforMUSIM) may be a new IE and may indicate whether measurement gap is required for the UE to perform measurements (e.g., SSB based measurements, CSI-RS based measurement, and/or RRM measurements, etc.) and MUSIM operation on an NR target band and/or the required time periods. The MUSIM operation described by the IE may include measurement, paging reception, SI reception and/or access procedure toward network 100B. The new capability may be indicated per UE, per band, and/or per band per band combination. In other words, the IE may indicate the time periods/capability for the UE generally (e.g., regardless of the band(s) used by the networks), for a particular band (e.g., a first band of network 100A and a second band of network 100B), and/or for a combination of bands for the two networks.

The IE may indicate one or more NCSG patterns that the UE supports. For example, patterns may be indicated according to the following table. The supported (e.g., and/or unsupported) patterns may be indicated by pattern ID, etc. It will be appreciated that patterns 2-22 may be omitted from the table as presented below for purposes of illustration. In the table below, patterns 24-38 may be new patterns, e.g., relative to table 9.1.9.3-1 of TS 38.133. Longer VIRP, e.g., as in the new patterns, may be good for UE power saving, e.g., in the case that these patterns are used for MUSIM operation. Additional and/or different patterns or tables may be used as desired.

| | | Visible Interruption |
|---|---|---|
| NCSG Pattern ID | Measurement Length (ML) | Repetition Period (VIRP) |
| 0 | 5 | 40 |
| 1 | 5 | 80 |
| . . . | . . . | . . . |
| 23 | 1 | 160 |
| 24 | 6 | 320 |
| 25 | 6 | 640 |
| 26 | 6 | 1280 |
| 27 | 6 | 2560 |
| 28 | 10 | 320 |
| 29 | 10 | 640 |
| 30 | 10 | 1280 |
| 31 | 10 | 2560 |
| 32 | 20 | 320 |
| 33 | 20 | 640 |
| 34 | 20 | 1280 |
| 35 | 20 | 2560 |
| 36 | 20 | 5120 |
| 37 | 10 | NA |
| 38 | 20 | NA |

Note 1:
Measurement gap pattern #37, #38 may be aperiodic gap patterns, e.g., without VIRP.

As another possibility, the UE may use an IE specific for MUSIM operation (e.g., NeedforGapsforMUSIM) to indicate whether the UE requests gaps for MUSIM operation. The IE NeedForGapsforMUSIM may be a new IE and may indicate whether measurement gap is requested (e.g., or required) for the UE to perform measurements (e.g., SSB based measurements, CSI-RS based measurement, and/or RRM measurements, etc.) and MUSIM operation on an NR target band. Further, the IE may indicate ML, VIRP, VIL1, and/or VIL2 or similar parameters. The IE may include a bitmap to indicate the supported NCSG pattern(s), according to some embodiments. The MUSIM operation described by the IE may include measurement, paging reception, SI reception and/or access procedure toward network 100B. The new capability may be indicated per UE, per band, and/or per band per band combination.

As one example of the per band per band combination approach (e.g., for NCSGforMUSIM and/or for NeedforGapsforMUSIM), the UE may be working with carrier aggregation (CA) in network A as follows. A primary cell (PCell) (cell 1) on Band 1, and a secondary cell (SCell) (cell 2) on Band 2. The UE may be capable of monitoring both Band 1 and Band 2 of network 100A using a single RF chain, e.g., leaving a second RF chain available for network 100B. The UE may perform MUSIM operation on network 100B. There may also be two bands in network B: neighbor cell (cell 3) on Band 2, and neighbor cell (cell 4) on Band 3. For a per band per band combination feature, the UE may indicate support of the feature (e.g., and relevant parameters, e.g., which may be specific to the band/combination) on particular bands. For example, the UE may indicate support on Band 2, but no support on Band 3.

In the case of NCSG, in this example, if UE only needs to perform MUSIM operation on Band 2 (e.g., and thus indicates that a gap is needed on Band 2 using the IE), then network 100A can configure new MUSIM NCSG gap for the UE (e.g., on Band 2). For example, the network 100A If UE needs to perform MUSIM operation on Band 3, network 100A may configure legacy MUSIM gap since the new MUSIM NCSG gap is not supported on Band 3.

In the case of NeedforGaps, in this example, if UE only needs to perform MUSIM operation on Band 2 (e.g., and thus indicates that a gap is needed on Band 2 using the IE), then network 100A can configure new MUSIM gap for the UE. If UE needs to perform MUSIM operation on Band 3, network 100A may configure legacy MUSIM gap since the new MUSIM gap is not supported on Band 3. According to some embodiments, for a new MUSIM gap, the UE may be available for communication with network 100A during a period of time that it is also communicating with network 100B, but not during a period when the UE is tuning one RF chain from network 100A to 100B. According to a legacy MUSIM gap, the UE may not be available for communication with network 100A during the entire gap, e.g., including the period of communication with network 100B. It will be appreciated that ML and VIL may not yet be specified for NeedForGaps by 3GPP, however similar concepts may be used as desired. In some embodiments, because ML and VIL may not be specified, the network may not know exactly when the UE can (e.g., and cannot) be scheduled.

It will be appreciated that the IE names given here are possible example names. The IE(s) may be named differently in future standards.

The communication with the first network 100A may use a first subscriber identity module (SIM) of the UE.

The first network may determine an initial measurement configuration for the UE (604), according to some embodiments. The initial measurement configuration may include interfrequency measurements, e.g., of cells/TRPs of the first network 110A. For example, the initial measurement configuration may include one or more measurement gaps, e.g., time periods during which the UE may tune away from a serving cell/TRP to perform the measurement.

In some embodiments, the measurement period may be configured using an NCSG pattern. For example, the measurement period may be similar to the illustration of FIG. 7 and/or may use a pattern (or patterns) as illustrated in the table above.

The first network 100A may transmit an indication of the initial measurement configuration to the UE (606), according to some embodiments. The indication may be transmitted using RRC signaling, for example. The UE may receive the indication and may perform measurement(s) according to the configuration.

It will be appreciated that 602, 604, and 606 are illustrated as occurring prior to 608. However, 608 may occur prior to any or all of these. Further, in some embodiments, 602, 604 and/or 606 may be omitted.

The UE may establish communication with a second wireless network (e.g., network 100B) (608), according to some embodiments. The communication may be as described as above with respect to 602, e.g., the network may be a cellular network communicating with the UE via any number of base stations/TRPs using any RAT(s). However, it will be appreciated that the network 100B and various aspects of the communication with network 100B may be different than corresponding aspects of the communication with network 100A. For example, the communication with network 100B may use the same and/or different RAT(s) than that with network 100A. Similarly, the UE and network 100B may exchange configuration information, e.g., the UE may provide capability information. Further, the network 100B may determine measurement configuration for the UE (e.g., as discussed with respect to 604, noting that the measurement configuration may differ for the different networks) and indicate the configuration to the UE (e.g., as in 606, noting that the method of indication may be the same and/or different).

The communication with the second network 100B may use a second SIM of the UE. In other words, the second network may be associated with a different SIM at the UE than the first network.

The UE may determine its capability(ies) with respect to communicating with the networks 100A and 100B (610) and indicate the capability(ies) to the network 100A (612), according to some embodiments. For example, the determination may be performed in response to determining that the UE is in communication with two (or more) different wireless networks.

The UE may determine whether it is capable of using different RF chains to communicate with the different networks simultaneously. The UE may determine information which may include information related to the UE's time requirements related to switching one or more RF chain between one network and another (e.g., between network 100A and network 100B), e.g., as discussed with respect to 602 above. For example, the UE may determine any or all of the timing and/or other parameters regarding use of NCSG and/or NeedForGap. This determination may be first performed after communication with both networks is established and/or may be performed when only communication with one network is established. For example, if an initial determination is performed in 602, the capabilities may be updated (e.g., in 610 and 612) based on specifics of the communication with the different networks (e.g., frequency bands, types of communication active/desired with each network, etc.). In other words, the information about communication with multiple networks may be indicated to network 100A at any time during or subsequent to establishing communication (e.g., in 602 and/or 612).

As discussed above, the UE may determine this capability based on the frequency bands and/or combinations of frequency bands in use for communication with networks 100A and 100B, according to some embodiments. Alternatively, the UE may make the determination without regard to the frequency bands.

In some embodiments, in addition to the capability information, the UE may indicate one or more parameters of its communication with network 100B to network 100A.

The UE may use any of the IEs discussed above to provide and/or update the capability information to the network 100A, among various possibilities.

In some embodiments, the UE may also determine and provide similar capability information to network 100B.

The first network 100A may determine a MUSIM configuration for the UE (614), according to some embodiments. The network 100A may determine the configuration based on the information provided by the UE (e.g., in 602 and/or 612). For example, the network 100A may determine a schedule for the UE to switch one RF chain (of the UE) from communication with network 100A to/from network 100B, e.g., while the UE maintains communication with network 100A with a different RF chain. For example, the network may configure an NCSG and/or NeedforGap configuration for the UE.

In the case of an NCSG configuration, after receiving the UE capability information, network 100A may know that the UE can support using NCSG for MUSIM operation toward network 100B. Thus, when the UE indicates to network 100A that it is performing (e.g., or is going to perform) MUSIM operation toward network 100B, network 100A may not specifically configure a legacy measurement gap for MUSIM operation. Instead, network 100A may configure NCSG for the UE, e.g., according to one of the NCSG patterns that the UE supports. For example, the network 100A may avoid scheduling any communication with the UE during VIL periods of the NCSG pattern. During ML periods of the NCSG pattern, network 100A may schedule communications that the UE can perform with a first RF chain while a second RF chain is tuned away from network 100A. During other periods of the NCSG pattern, network 100A may schedule communications that the UE may perform with the first and/or second RF chain.

In the case of a NeedforGap configuration, after receiving the UE capability information, network 100A may know that a gap is not needed for MUSIM operation toward network 100B. When the UE indicates to network 100A that it is going to perform MUSIM operation toward network 100B, network 100A may not specifically configure measurement gap for MUSIM operation. Further, if network 100A has already configured a measurement gap (e.g., for interfrequency measurements of network 100A, as discussed with respect to 604), the network 100A may not cancel the gap. Instead, network 100A may determine whether or not to use the gap for the MUSIM operation. Accordingly, the network 100A may use a flag (e.g., in an RRC message, MAC message, and/or DCI) to indicate whether the UE should use the gap for MUSIM.

For example, the flag may be configured so that if the flag is on, the UE may perform the MUSIM operation (e.g., switch one or more RF chains from network 100A to network 100B and back) within the configured measurement gap. This approach may have the advantage of not causing any short interruptions (e.g., due to the switching to/from network 100B) outside of the gap. However, this approach may have the disadvantage of negatively impacting the measurements of network 100A during the gap (e.g., increasing the latency, etc.). If the flag is off, the UE may perform the operation outside of the gap. The time of such measurements may be at the discretion of the UE (e.g., and/or network 100B). In some embodiments, the network 100A may request the UE to indicate when it will perform the MUSIM operation toward network 100B. If the flag is off, the measurements may not be negatively impacted, but the UE may experience short interruptions with respect to network 100A when the RF chain(s) is/are switched between networks.

The first network 100A may indicate the MUSIM configuration to the UE (616), according to some embodiments. The UE may receive the indication. The configuration may be transmitted via RRC signaling, among various possibilities.

In some embodiments, if a flag is used to indicate whether the UE should use a configured measurement gap for MUSIM, the flag may be transmitted via DCI, e.g., so that the flag may be changed as desired for different measurement gap periods.

The UE may determine timing of communication with the first and second networks (618), according to some embodiments. The UE may determine the timing according to the configuration received from network 100A. For example, the UE may determine a pattern of times for communication with network 100B so that one or more second RF chain switches to/from network 100B (e.g., and from/to network 100A) while one or more first RF chain remains tuned to network 100A.

It will be appreciated that in some embodiments 608 may occur after 618. For example, the UE may determine to establish communication with the second network 100B. Based on that determination, the UE may determine capabilities and indicate them to the first network 100A (e.g., as discussed in 610 and 612). Further, the network 100A may determine a configuration and indicate it to the UE (e.g., as discussed in 614 and 616). The UE may determine timing for communication with the two networks (e.g., as discussed in 618). Then, the UE may establish communication with the second network 100B (e.g., as discussed in 608).

The UE may perform communication with the first network 100A (620a) and with the second network 100B (620b), according to some embodiments. The communication may be according to the timing determined in 618. The UE may not request a measurement gap to perform MUSIM operation. For example, according to the pattern, at some times the first and second RF chains may be tuned to network 100A, at other times the first RF chain(s) may be tuned to network 100A while the second RF chain(s) may be tuned to network 100B. Communication with both networks 100A and 100B may be interrupted when the second RF chain(s) switch between networks. Thus, communication with both networks may be simultaneous, e.g., during the portion(s) of a period of the pattern when the first and second RF chains are tuned to networks 100A and 100B, respectively.

The second network 100B and the UE may end communication (622), according to some embodiments. For example, the UE may travel out of range of network 100B and/or pause communication with the network 100B.

The UE may indicate the end of communication with network 100B to network 100A (624), according to some embodiments. In response, network 100A may update the configuration of the UE. For example, the network 100A may select a different NCSG configuration. Similarly, the network 100A may set a flag to off for use of a measurement gap for MUSIM. Among various possibilities, the network 100A may return to the initial measurement configuration (e.g., as discussed in 604). The network 100A may indicate the updated configuration to the UE (e.g., using RRC signaling, for example).

Note that 622 and/or 624 may be omitted. Alternatively, the UE may end communication with network 100A prior to or simultaneously with ending communication with network 100B.

Thus, at least according to some embodiments, the method of FIG. 6 may be used to provide a framework according to which a wireless device may be configured to perform communication with multiple networks, e.g., using different RF chains to communicate simultaneously. The wireless device may provide information to assist a cellular network to effectively and efficiently schedule and perform wireless communications with the wireless device, at least in some instances.

Although aspects of FIG. 6 are illustrated and described with respect to two wireless networks, it will be appreciated that the techniques of FIG. 6 may be applied for communication with three or more wireless networks.

In the following further exemplary embodiments are provided.

One set of embodiments may include a method at a user equipment device (UE) may comprise establishing communication with a first wireless network using a first subscriber identity module (SIM) of the UE and establishing communication with a second wireless network using a second SIM of the UE, wherein the second SIM of the UE is different than the first SIM of the UE. The method may include determining that the UE the UE is capable of communicating with the first wireless network using a first radio frequency (RF) chain while simultaneously communicating with the second wireless network using a second RF chain. In response to the determination that the UE the UE is capable of communicating with the first wireless network using the first RF chain while simultaneously communicating with the second wireless network using the second RF chain, the method may include transmitting, to the first wireless network, an indication that the UE is capable of using network controlled short gap (NCSG) with respect to the first wireless network for communication with the second wireless network. The method may further include receiving, from the first wireless network, an indication of a first NCSG configuration. In response to the indication, the method may include determining to communicate, with the second wireless network using the second RF chain, during a first portion of a visible interruption repetition period (VIRP) according to the first NCSG configuration and not to communicate with the second wireless network during a second portion of the VIRP according to the first NCSG configuration; and determining to communicate, with the first wireless network using the first RF chain, during the first portion of the VIRP and during the second portion of the VIRP using the first RF chain.

One set of embodiments may include a method at a user equipment device (UE) may comprise establishing communication with a first wireless network using a first subscriber identity module (SIM) of the UE and establishing communication with a second wireless network using a second SIM of the UE, wherein the second SIM of the UE is different than the first SIM of the UE. The method may include determining that the UE the UE is capable of communicating with the first wireless network using a first radio frequency (RF) chain while simultaneously communicating with the second wireless network using a second RF chain. In response to the determination that the UE the UE is capable of communicating with the first wireless network using the first RF chain while simultaneously communicating with the second wireless network using the second RF chain, the method may include transmitting, to the first wireless network, an indication that the UE has a capability to perform communication with the second wireless network without a measurement gap with respect to the first wireless network; and performing communication with the first wireless network using the first RF chain while simultaneously performing communication with the second wireless network using the second RF chain.

According to some embodiments, the indication that the UE is capable of using NCSG with respect to the first wireless network for communication with the second wireless network comprises an indication of at least one NCSG configuration supported by the UE, the at least one NCSG configuration supported by the UE comprising at least the first NCSG configuration.

According to some embodiments, the indication that the UE is capable of using NCSG with respect to the first wireless network for communication with the second wireless network is specific to a first frequency band.

According to some embodiments, the indication that the UE is capable of using NCSG with respect to the first wireless network for communication with the second wireless network is specific to a first combination of frequency bands.

According to some embodiments, the indication that the UE is capable of using NCSG with respect to the first wireless network for communication with the second wireless network comprises an indication of a measurement length (ML), wherein the first portion of the VIRP comprises the ML.

According to some embodiments, 3.

the indication that the UE is capable of using NCSG with respect to the first wireless network for communication with the second wireless network comprises an indication of a visible interruption length (VIL), wherein the first portion of the VIRP does not comprise the VIL and the second portion of the VIRP does not comprise the VIL.

According to some embodiments, the first NCSG configuration corresponds to one of the NCSG pattern IDs shown in the table above.

According to some embodiments, the indication that the UE is capable of using NCSG with respect to the first wireless network for communication with the second wireless network is not restricted based on frequency band.

According to some embodiments, the indication that the UE is capable of using NCSG with respect to the first wireless network for communication with the second wireless network comprises an NCSGforMUSIM information element.

In one set of embodiments, a method at a user equipment device (UE) may comprise establishing communication with a first wireless network using a first subscriber identity module (SIM) of the UE and establishing communication with a second wireless network using a second SIM of the UE, wherein the second SIM of the UE is different than the first SIM of the UE. The method may include determining that the UE the UE is capable of communicating with the first wireless network using a first radio frequency (RF) chain while simultaneously communicating with the second wireless network using a second RF chain. In response to the determination that the UE the UE is capable of communicating with the first wireless network using the first RF chain while simultaneously communicating with the second wireless network using the second RF chain, the method may include transmitting, to the first wireless network, an indication that the UE has a capability to perform communication with the second wireless network without a measurement gap with respect to the first wireless network; and performing communication with the first wireless network using the first RF chain while simultaneously performing communication with the second wireless network using the second RF chain.

According to some embodiments, the method may further comprise: prior to transmitting the indication that the UE has a capability to perform communication with the second wireless network without the measurement gap with respect to the first wireless network, receiving, from the first wireless network a configuration of a second measurement gap for interfrequency measurements of the first wireless network.

According to some embodiments, the method may further comprise: after transmitting the indication that the UE has a capability to perform communication with the second wireless network without the measurement gap with respect to the first wireless network, receiving, from the first wireless network an indication to perform communication with the second wireless network during the second measurement gap.

According to some embodiments, the method may further comprise: after transmitting the indication that the UE has a capability to perform communication with the second wireless network without the measurement gap with respect to the first wireless network, receiving, from the first wireless network an indication to perform communication with the second wireless network outside of the second measurement gap.

According to some embodiments, the method may further comprise: transmitting, to the first wireless network, an indication of a length of an interruption of communication using the first RF chain associated with activating the second RF chain.

According to some embodiments, the method may further comprise: transmitting, to the first wireless network, an indication of a length of an interruption of communication using the first RF chain associated with deactivating the second RF chain.

One set of embodiments may include a method at cellular base station of a first wireless network may include establishing communication with a user equipment device (UE) and receiving, from the UE, an indication that the UE is capable of communicating with the first wireless network using a first radio frequency (RF) chain while simultaneously communicating with the second wireless network using a second RF chain. In response to the indication that the UE the UE is capable of communicating with the first wireless network using the first RF chain while simultaneously communicating with the second wireless network using the second RF chain, the method may include selecting a configuration for the UE to perform operations with respect to the second wireless network; and transmitting, to the UE an indication of the configuration.

A further exemplary embodiment may include a method, comprising: performing, by a wireless device, any or all parts of the preceding examples.

Another exemplary embodiment may include a device, comprising: an antenna; a radio coupled to the antenna; and a processing element operably coupled to the radio, wherein the device is configured to implement any or all parts of the preceding examples.

A further exemplary set of embodiments may include a non-transitory computer accessible memory medium comprising program instructions which, when executed at a device, cause the device to implement any or all parts of any of the preceding examples.

A still further exemplary set of embodiments may include a computer program comprising instructions for performing any or all parts of any of the preceding examples.

Yet another exemplary set of embodiments may include an apparatus comprising means for performing any or all of the elements of any of the preceding examples.

Still another exemplary set of embodiments may include an apparatus comprising a processing element configured to cause a wireless device to perform any or all of the elements of any of the preceding examples.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Any of the methods described herein for operating a user equipment (UE) may be the basis of a corresponding method for operating a base station, by interpreting each message/signal X received by the UE in the downlink as message/signal X transmitted by the base station, and each message/signal Y transmitted in the uplink by the UE as a message/signal Y received by the base station.

Embodiments of the present disclosure may be realized in any of various forms. For example, in some embodiments, the present subject matter may be realized as a computer-implemented method, a computer-readable memory medium, or a computer system. In other embodiments, the present subject matter may be realized using one or more custom-designed hardware devices such as ASICs. In other embodiments, the present subject matter may be realized using one or more programmable hardware elements such as FPGAs.

In some embodiments, a non-transitory computer-readable memory medium (e.g., a non-transitory memory element) may be configured so that it stores program instructions and/or data, where the program instructions, if executed by a computer system, cause the computer system to perform a method, e.g., any of a method embodiments described herein, or, any combination of the method embodiments described herein, or, any subset of any of the method embodiments described herein, or, any combination of such subsets.

In some embodiments, a device (e.g., a UE) may be configured to include a processor (or a set of processors) and a memory medium (or memory element), where the memory medium stores program instructions, where the processor is configured to read and execute the program instructions from the memory medium, where the program instructions are executable to implement any of the various method embodiments described herein (or, any combination of the method embodiments described herein, or, any subset of any of the method embodiments described herein, or, any combination of such subsets). The device may be realized in any of various forms.

Although the embodiments above have been described in considerable detail, numerous variations and modifications will become apparent to those skilled in the art once the above disclosure is fully appreciated. It is intended that the following claims be interpreted to embrace all such variations and modifications.

1. A method, comprising:
communicating with a first wireless network using a first subscriber identity module (SIM);
communicating with a second wireless network using a second SIM, wherein the second SIM is different than the first SIM;
determining a capability of communicating with the first wireless network using a first radio frequency (RF) chain while simultaneously communicating with the second wireless network using a second RF chain;
in response to the determination of the capability of communicating with the first wireless network using the first RF chain while simultaneously communicating with the second wireless network using the second RF chain, transmitting, to the first wireless network, an indication of a capability of using network controlled short gap (NCSG) with respect to the first wireless network for communication with the second wireless network;
receiving, from the first wireless network, an indication of a first NCSG configuration; and
in response to the indication:
determining to communicate, with the second wireless network using the second RF chain, during a first portion of a visible interruption repetition period (VIRP) according to the first NCSG configuration and not to communicate with the second wireless network during a second portion of the VIRP according to the first NCSG configuration; and
determining to communicate, with the first wireless network using the first RF chain, during the first portion of the VIRP and during the second portion of the VIRP using the first RF chain.

2. The method of claim 1, wherein the indication of the capability of using NCSG with respect to the first wireless network for communication with the second wireless network comprises an indication of at least one supported NCSG configuration, the at least one supported NCSG configuration comprising at least the first NCSG configuration.

3. The method of claim 1, wherein the indication of the capability of using NCSG with respect to the first wireless network for communication with the second wireless network is specific to a first frequency band.

4. The method of claim 1, wherein the indication of the capability of using NCSG with respect to the first wireless network for communication with the second wireless network is specific to a first combination of frequency bands.

5. The method of claim 1, wherein the indication of the capability of using NCSG with respect to the first wireless network for communication with the second wireless network comprises an indication of a measurement length (ML), wherein the first portion of the VIRP comprises the ML.

6. The method of claim 5, wherein the indication of the capability of using NCSG with respect to the first wireless network for communication with the second wireless network comprises an indication of a visible interruption length (VIL), wherein the first portion of the VIRP does not comprise the VIL and the second portion of the VIRP does not comprise the VIL.

7. The method of claim 1, wherein the first NCSG configuration corresponds to one of the NCSG pattern IDs shown in the following table:

| | | Visible Interruption |
|---|---|---|
| NCSG Pattern ID | Measurement Length (ML) | Repetition Period (VIRP) |
| 0 | 5 | 40 |
| 1 | 5 | 80 |
| . . . | . . . | . . . |
| 23 | 1 | 160 |
| 24 | 6 | 320 |
| 25 | 6 | 640 |
| 26 | 6 | 1280 |
| 27 | 6 | 2560 |
| 28 | 10 | 320 |
| 29 | 10 | 640 |
| 30 | 10 | 1280 |
| 31 | 10 | 2560 |
| 32 | 20 | 320 |
| 33 | 20 | 640 |
| 34 | 20 | 1280 |
| 35 | 20 | 2560 |
| 36 | 20 | 5120 |
| 37 | 10 | NA |
| 38 | 20 | NA |

Note 1:
Measurement gap pattern #37, #38 may be aperiodic gap patterns without VIRP.

8. The method of claim 1, wherein the indication of the capability of using NCSG with respect to the first wireless network for communication with the second wireless network is not restricted based on frequency band.

9. The method of claim 1, wherein the indication of the capability of using NCSG with respect to the first wireless network for communication with the second wireless network comprises an NCSGforMUSIM information element.

10. An apparatus, comprising:
a processor configured to, when executing instructions stored in a memory, perform operations comprising:
communicating with a first wireless network using a first subscriber identity module (SIM);
communicating with a second wireless network using a second SIM, wherein the second SIM is different than the first SIM;
determining a capability of communicating with the first wireless network using a first radio frequency (RF) chain while simultaneously communicating with the second wireless network using a second RF chain;
in response to the determination of the capability of communicating with the first wireless network using the first RF chain while simultaneously communicating with the second wireless network using the second RF chain, transmitting, to the first wireless network, an indication of a capability of using network controlled short gap (NCSG) with respect to the first wireless network for communication with the second wireless network;
receiving, from the first wireless network, an indication of a first NCSG configuration; and
in response to the indication:
determining to communicate, with the second wireless network using the second RF chain, during a first portion of a visible interruption repetition period (VIRP) according to the first NCSG configuration and not to communicate with the second wireless network during a second portion of the VIRP according to the first NCSG configuration; and
determining to communicate, with the first wireless network using the first RF chain, during the first portion of the VIRP and during the second portion of the VIRP using the first RF chain.

11. The apparatus of claim 10, wherein the indication of the capability of using NCSG with respect to the first wireless network for communication with the second wireless network comprises an indication of at least one supported NCSG configuration, the at least one supported NCSG configuration comprising at least the first NCSG configuration.

12. The apparatus of claim 10, wherein the indication of the capability of using NCSG with respect to the first wireless network for communication with the second wireless network is specific to a first frequency band.

13. The apparatus of claim 10, wherein the indication of the capability of using NCSG with respect to the first wireless network for communication with the second wireless network is specific to a first combination of frequency bands.

14. The apparatus of claim 10, wherein the indication of the capability of using NCSG with respect to the first wireless network for communication with the second wireless network comprises an indication of a measurement length (ML), wherein the first portion of the VIRP comprises the ML.

15. The apparatus of claim 14, wherein the indication of the capability of using NCSG with respect to the first wireless network for communication with the second wireless network comprises an indication of a visible interruption length (VIL), wherein the first portion of the VIRP does not comprise the VIL and the second portion of the VIRP does not comprise the VIL.

16. The apparatus of claim 10, wherein the first NCSG configuration corresponds to one of the NCSG pattern IDs shown in the following table:

| | | Visible Interruption |
|---|---|---|
| NCSG Pattern ID | Measurement Length (ML) | Repetition Period (VIRP) |
| 0 | 5 | 40 |
| 1 | 5 | 80 |
| . . . | . . . | . . . |
| 23 | 1 | 160 |
| 24 | 6 | 320 |
| 25 | 6 | 640 |
| 26 | 6 | 1280 |
| 27 | 6 | 2560 |
| 28 | 10 | 320 |
| 29 | 10 | 640 |
| 30 | 10 | 1280 |
| 31 | 10 | 2560 |
| 32 | 20 | 320 |
| 33 | 20 | 640 |
| 34 | 20 | 1280 |
| 35 | 20 | 2560 |
| 36 | 20 | 5120 |
| 37 | 10 | NA |
| 38 | 20 | NA |

Note 1:
Measurement gap pattern #37, #38 may be aperiodic gap patterns without VIRP.

17. The apparatus of claim 10, wherein the indication of the capability of using NCSG with respect to the first wireless network for communication with the second wireless network is not restricted based on frequency band.

18. A method, comprising:
at a cellular base station of a first wireless network:
communicating with a user equipment device (UE);
receiving, from the UE, an indication that the UE is capable of communicating with the first wireless network using a first radio frequency (RF) chain while simultaneously communicating with a second wireless network using a second RF chain;
in response to the indication that the UE the UE is capable of communicating with the first wireless network using the first RF chain while simultaneously communicating with the second wireless network using the second RF chain:
selecting a configuration for the UE to perform operations with respect to the second wireless network; and
transmitting, to the UE an indication of the configuration.

19. The method of claim 18, wherein the indication of the capability of using NCSG with respect to the first wireless network for communication with the second wireless network comprises an indication of at least one supported NCSG configuration, the at least one supported NCSG configuration comprising at least a first NCSG configuration.

20. The method of claim 18, wherein the indication of the capability of using NCSG with respect to the first wireless network for communication with the second wireless network is specific to a first frequency band.
